(19) United States
(12) Patent Application Publication
(10) Pub. No.: US 2020/0258057 A1
(43) Pub. Date: Aug. 13, 2020

(54) REPAIR MANAGEMENT AND EXECUTION

(71) Applicant: HITACHI, LTD., Tokyo (JP)

(72) Inventors: Ahmed Khairy FARAHAT, Santa Clara, CA (US); Chetan GUPTA, Santa Clara, CA (US); Marcos VIEIRA, Santa Clara, CA (US); Susumu SERITA, Santa Clara, CA (US)

(21) Appl. No.: 16/332,101

(22) PCT Filed: Oct. 6, 2017
(86) PCT No.: PCT/US17/55461

§ 371 Date: Mar. 11, 2019

(51) Int. Cl. G06Q 10/00; G06N 3/04; G06N 3/08; G06N 5/00; G06N 7/00; G06N 20/00; G10L 15/187

(52) U.S. Cl. CPC G06Q 10/20; G06N 3/0454; G06N 3/08; G10L 15/187; G06N 7/005; G06N 20/00; G06N 5/003

(57) ABSTRACT

In some examples, a computer system may receive historical repair data for equipment and/or domain knowledge related to the equipment. The system may construct a hierarchical data structure for the equipment including a first hierarchy and a second hierarchy, the first hierarchy including a plurality of equipment nodes corresponding to different equipment types, and the second hierarchy including a plurality of repair category nodes corresponding to different repair categories. The system may generate a plurality of machine learning models corresponding to the plurality of repair category nodes, respectively. When the system receives a repair request associated with the equipment, the system determines a certain one of the equipment nodes associated with the equipment, and based on determining that a certain repair category node is associated with the certain equipment node, uses the machine learning model associated with the certain repair category node to determine one or more repair actions.

### TECHNICAL FIELD

This disclosure relates to the technical field of equipment repair management and execution.

### BACKGROUND

When complex equipment experiences a failure, it may be difficult and time-consuming to determine the cause of the failure and a corresponding repair action for returning the equipment to a functioning condition. Furthermore, with aging technicians leaving the workforce in some industries, there may be a knowledge gap created in which newer technicians may not have sufficient experience to easily determine a cause of a failure and a suitable repair procedure for correcting the failure.

### SUMMARY

Implementations herein include arrangements and techniques for determining one or more repair actions in response to a repair request. In some examples, a computer system may receive historical repair data for equipment and/or domain knowledge related to the equipment. The system may construct a hierarchical data structure for the equipment including a first hierarchy and a second hierarchy, the first hierarchy including a plurality of equipment nodes corresponding to different equipment types, and the second hierarchy including a plurality of repair category nodes corresponding to different repair categories. The system may generate a plurality of machine learning models corresponding to the plurality of repair category nodes, respectively. When the system receives a repair request associated with the equipment, the system determines a certain one of the equipment nodes associated with the equipment, and based on determining that a certain repair category node is associated with the certain equipment node, uses the machine learning model associated with the certain repair category node to determine one or more repair actions based on the received repair request.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a computer system able to determine and implement repairs according to some implementations.

FIG. 2 includes three example flow diagrams illustrating processes that may be executed by the repair management program and other functional components.

FIG. 3 illustrates an example of extracting relevant data and relevant data features according to some implementations.

FIG. 4 illustrates an example output received from a trained machine learning model according to some implementations.

FIG. 5 illustrates an example hierarchical data structure and corresponding hierarchy of machine learning models according to some implementations.

FIG. 6 illustrates an example confusion matrix that may be used to determine machine learning model performance according to some implementations.

FIG. 7 illustrates an example graph for determining which machine learning model to employ according to some implementations.

FIG. 8 is a flow diagram illustrating an example process for determining a repair action according to some implementations.

FIG. 9 is a flow diagram illustrating an example process for generating and applying a hierarchy of machine learning models according to some implementations.

### DESCRIPTION OF THE EMBODIMENTS

Some implementations herein are directed to techniques and arrangements for a system that determines one or more repair actions in response to receiving a repair request following an equipment failure. Examples of equipment failures herein may include breakdown events, such as when the equipment cannot be operated, as well as soft failures, such as partial operation, inefficient operation, or otherwise abnormal operation of the equipment or one of its components. Implementations herein include a data-driven system for determining repair actions and repair plans, such as to instruct repair personnel or other repairer on how to repair the equipment and/or for instructing the equipment itself to perform a repair procedure.

Additionally, some implementations herein may employ a hierarchical configuration of machine learning models that may be used for determining one or more repair options and one or more corresponding repair plans. Accordingly, a plurality of machine learning models may be generated and arranged in a hierarchy based on a configuration of a hierarchical data structure determined for the equipment. For instance, the hierarchical data structure may be determined from domain knowledge related to the equipment and/or the historical repair data for the equipment, and may include a first hierarchy based on equipment type and a second hierarchy based on repair type. Upon receiving a repair request, the hierarchical data structure may be used for determining one or more of the machine learning models to execute for determining the one or more repair options.

As one example, the system may receive as input: (1) data about the equipment and the working environment of the equipment, and (2) natural language complaints or other information from a user of the equipment regarding the failure in need of repair. In response, the system may input the received information to one or more trained machine learning models for determining one or more repair actions. For example, the system may have trained one or more machine learning models using historical repair records and data associated with the repair records as training data for training the machine learning models for determining repair actions. Based on the output of the machine learning model(s), the system may determine one or more repair plans. In some examples, a repair plan may be sent as instructions to the location of the equipment, such as to a repairer computing device or to the equipment itself. In other examples, the system itself may execute the repair plan, such as by remotely initiating a repair procedure at the equipment, ordering one or more parts for the repair, assigning labor for executing the repair, scheduling a time for the repair to be performed, or the like. Accordingly, the system herein may implement repairs, reduce the amount of time that equipment is out of service, increase the efficiency of the repair process, and reduce the likelihood of repair mistakes.

In some examples, a computer system may receive historical repair data for the equipment. The system may identify and extract free-form text in the historical repair data, such as words, phrases, topics, or other free-form text. The system may determine one or more n-grams from the free-form text and may define at least one feature for the free-form text based on assigning one or more values to the one or more n-grams. The system may also extract a plurality of other features from the historical repair data and/or from domain knowledge about the equipment. Examples of the plurality of other features may include equipment attributes, usage data, sensor data, structured text, and other data. The system may train at least one machine learning model using the at least one feature and the plurality of other features. The system may receive a repair request associated with the equipment and may use the at least one trained machine learning model to determine at least one repair action based on the received repair request.

The users of the system herein may include, but are not limited to, equipment end-users and/or operators; repair and maintenance personnel and management; and decision makers and operation managers. The system herein may be used as a standalone solution or may be integrated with other existing systems that provide other functionalities for maintenance management and maintenance optimization.

For discussion purposes, some example implementations are described in the environment of a computer system that determines repair actions and repair plans for equipment. However, implementations herein are not limited to the particular examples provided, and may be extended to other types of equipment, other environments of use, other system architectures, other applications, and so forth, as will be apparent to those of skill in the art in light of the disclosure herein.

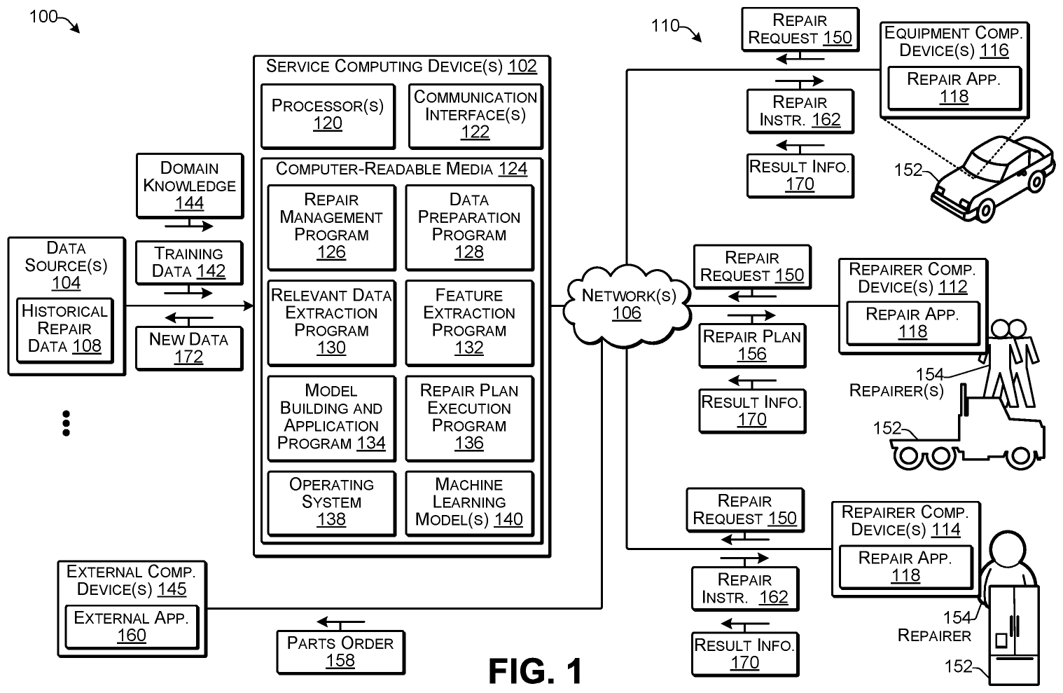

FIG. 1 illustrates an example architecture of a computer system 100 able to determine and implement repairs according to some implementations. The system 100 includes at least one service computing device 102 that is able to communicate directly or indirectly with one or more data sources 104. For example, each data source 104 may be a storage directly connected to the service computing device 102, may be a storage connected through one or more networks 106, may be another computing device that maintains a database of historical repair data 108, such as through a network, may be a cloud storage location, or other network or local storage location that the service computing device 102 accesses to retrieve the historical repair data 108, may be any combination of the foregoing, or any of various other configurations, as will be apparent to those of skill in the art having the benefit of the disclosure herein. Accordingly, implementations herein are not limited to any particular storage apparatus or technique for storing the historical repair data 108 or portions thereof.

The service computing device 102 may further communicate over the one or more networks 106 with one or more client computing devices 110, such as one or more repairer computing devices 112, one or more repairer computing devices 114, and/or one or more equipment computing devices 116, each of which may include a repair application 118. In some examples, the repair application 118 on each of the repairer computing devices 112, 114, and/or the equipment computing device 116 may include the same application features and functionality, while in other examples, the repair application 118 may be customized for individual repair environments in which it is to be used.

In some implementations, the service computing device 102 may include one or more servers, personal computers, embedded processors, or other types of computing devices that may be embodied in any number of ways. For instance, in the case of a server, the programs, other functional components, and at least a portion of data storage may be implemented on at least one server, such as in a cluster of servers, a server farm or data center, a cloud-hosted computing service, and so forth, although other computer architectures may additionally or alternatively be used.

In the illustrated example, the service computing device 102 includes, or otherwise may have associated therewith, one or more processors 120, one or more communication interfaces 122, and one or more computer-readable media 124. Each processor 120 may be a single processing unit or a number of processing units, and may include single or multiple computing units, or multiple processing cores. The processor(s) 120 may be implemented as one or more central processing units, microprocessors, microcomputers, microcontrollers, digital signal processors, state machines, logic circuitries, and/or any devices that manipulate signals based on operational instructions. For instance, the processor(s) 120 may be one or more hardware processors and/or logic circuits of any suitable type specifically programmed or configured to execute the algorithms and processes described herein. The processor(s) 120 may be configured to fetch and execute computer-readable instructions stored in the computer-readable media 124, which can program the processor(s) 120 to perform the functions described herein.

The computer-readable media 124 may include volatile and nonvolatile memory and/or removable and non-removable media implemented in any type of technology for storage of information such as computer-readable instructions, data structures, program modules, or other data. For example, the computer-readable media 124 may include, but is not limited to, RAM, ROM, EEPROM, flash memory or other memory technology, optical storage, solid state storage, magnetic tape, magnetic disk storage, RAID storage systems, object storage systems, storage arrays, network attached storage, storage area networks, cloud storage, or any other medium that can be used to store the desired information and that can be accessed by a computing device. Depending on the configuration of the service computing device 102, the computer-readable media 124 may be a tangible non-transitory medium to the extent that, when mentioned, non-transitory computer-readable media exclude media such as energy, carrier signals, electromagnetic waves, and/or signals per se. In some cases, the computer-readable media 124 may be at the same location as the service computing device 102, while in other examples, the computer-readable media 124 may be partially remote from the service computing device 102.

The computer-readable media 124 may be used to store any number of functional components that are executable by the processor(s) 120. In many implementations, these functional components comprise executable instructions and/or programs that are executable by the processor(s) 120 and that, when executed, specifically program the processor(s) 120 to perform the actions attributed herein to the service computing device 102. Functional components stored in the computer-readable media 124 may include a repair management program 126. The repair management program 126 may include one or more computer programs, computer-readable instructions, executable code, or portions thereof that are executable to cause the processor(s) 120 to perform various tasks as described herein. In the illustrated example, the repair management program 126 may include or may access a data preparation program 128, a relevant data extraction program 130, a feature extraction program 132, a model building and application program 134, and a repair plan execution program 136.

Each of these functional components 128-136 may be an executable module of the repair management program 126, or a portion thereof. Alternatively, in other examples, some or all of these components 128-136 may be separately executable stand-alone computer programs that may be invoked by the repair management program 126.

The data preparation program 128 may configure the one or more processors to prepare received input data by removing noise and transforming different data types to a format that can be useful for further analysis. The relevant data extraction program 130 may configure the one or more processors to extract, for each repair incident (historical or new), one or more subsets of data that contain symptoms of the problem that needs to be repaired. The feature extraction program 132 may configure the one or more processors to extract features from the relevant data associated with the equipment subject to repair. The model building and application program 134 may configure the one or more processors to build one or more machine learning models used for repair determination from the historical repair data, and may subsequently apply the one or more machine learning models to new repair incidents. Furthermore, the repair plan execution program 136 may configure the one or more processors to determine and execute one or more repair plans, such as for executing a repair plan, sending repair instructions to a repairer computing device, sending repair instructions to an equipment computing device, or the like.

Additionally, the functional components in the computer-readable media 124 may include an operating system 134 that may control and manage various functions of the service computing device 102. In some cases, the functional components may be stored in a storage portion of the computer-readable media 124, loaded into a local memory portion of the computer-readable media 124, and executed by the one or more processors 120. Numerous other software and/or hardware configurations will be apparent to those of skill in the art having the benefit of the disclosure herein.

In addition, the computer-readable media 124 may store data and data structures used for performing the functions and services described herein. For example, the computer-readable media 124 may store one or more machine learning models 140, and may store, at least temporarily, training data 142 used for training the machine learning models 140, as well as reports, client data, repair requests, and other information received from the client computing devices 110. In some examples, the computer readable media 124 may encompass the data source(s) 104, while in other examples, the computer readable media 124 may be separate from the data source(s) 104.

Further, the service computing device 102 may receive domain knowledge 144 related to the equipment from the one or more data sources 104. As discussed additionally below, domain knowledge is information related to the equipment and the environment in which the equipment operates that may be used for generating machine learning models 140, repair plans, and/or a hierarchical data structure for generating a hierarchy of machine learning models 140. In some examples, the domain knowledge 144 may include the historical repair data 108 or portions thereof. Additionally, or alternatively, in some cases the domain knowledge may be obtained from the historical repair data, i.e., the historical repair data may serve as the domain knowledge for the equipment.

The one or more machine learning models 140 may be used by one or more of the functional components, such as the model building and application program 134 for determining one or more repair solutions in response to information received from one or more of the client computing devices 110. Examples of the machine learning model(s) 140 may include classification models such as random forest, support vector machines, or deep learning networks. Additional examples of the machine learning models 140 may include predictive models, decision trees, regression models, such as linear regression models, stochastic models, such as Markov models and hidden Markov models, artificial neural networks, such as recurrent neural networks, and so forth. Accordingly, implementations herein are not limited to a particular type of machine learning model.

The service computing device(s) 102 may also include or maintain other functional components and data, which may include programs, drivers, etc., and the data used or generated by the functional components. Further, the service computing device(s) 102 may include many other logical, programmatic, and physical components, of which those described above are merely examples that are related to the discussion herein.

The communication interface(s) 122 may include one or more interfaces and hardware components for enabling communication with various other devices, such as over the one or more networks 106. Thus, the communication interfaces 122 may include, or may couple to, one or more ports that provide connection to the network(s) 106 for communicating with the data sources 104, the client computing device(s) 110, and/or one or more external computing devices 145. For example, the communication interface(s) 122 may enable communication through one or more of a LAN (local area network), WAN (wide area network), the Internet, cable networks, cellular networks, wireless networks (e.g., Wi-Fi) and wired networks (e.g., fiber optic, Ethernet, Fibre Channel,), direct connections, as well as short-range wireless communications, such as BLUETOOTH®, and the like, as additionally enumerated below.

Further, the client computing devices 110 and the one or more external computing devices 145 may include configurations and hardware similar to those discussed above, but with different functional components, such as the repair application 118, and different data. The client computing devices 110 may be any type of computing device able to communicate over a network including server computing devices, desktop computing devices, laptop computing devices, tablet computing devices, smart phone computing devices, wearable computing devices, embedded computing devices, such as electronic control units, and so forth.

The one or more networks 106 may include any type of network, including a LAN, such as an intranet; a WAN, such as the Internet; a wireless network, such as a cellular network; a local wireless network, such as Wi-Fi; short-range wireless communications, such as BLUETOOTH®; a wired network including fiber optics, Ethernet, Fibre Channel, or any other such network, a direct wired connection, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the service computing device(s) 102, the client computing device(s) 110, the external computing devices 145, and in some examples, the data sources 104, are able to communicate over the one or more networks 106 using wired or wireless connections, and combinations thereof.

In some implementations, the service computing device 102 may receive the training data 142 from the one or more data sources 104, such as by streaming or download. For instance, the model building and application program 134 may obtain the training data 142 from the historical repair data 108 and may provide the training data to the data preparation program 128, the relevant data extraction program 130, and the feature extraction program 132, as discussed additionally below. The model building and application program 134 may use the training data 142 to train the one or more machine learning models 140.

Subsequent to the training of the one or more machine learning models 140, the repair management program 126 may receive a repair request 150 from one of the client computing devices 110 requesting repair for a corresponding equipment 152. Examples of equipment 152 herein may include vehicles, appliances, construction equipment, manufacturing equipment, robots, electronics, or other types of devices, apparatuses, machines, or the like that may be subject to failure and that may be sufficiently complex such that the cause of a failure is not readily apparent to a repairer 154, such as repair personnel, maintenance personnel, or the like. Accordingly, implementations herein are not limited to particular types of equipment.

In response to receiving the repair request 150, the repair management program 126 may invoke the data preparation program 128, the relevant data extraction program 130, and the feature extraction program 132, as discussed additionally below, to prepare and/or extract data from the repair request 150 and determine model inputs from the information in the repair request 150. The repair management program 126 may further invoke the model building and application program 134 to apply the extracted information to the machine learning model(s) 140 to determine one or more probable repair solutions for the repair request. In some examples, the repair management program may also perform a cost-benefit analysis, as discussed additionally below, such as when a confidence in the result is below a threshold. In some cases, if a likely repair solution cannot be determined, the repair management program 126 may respond that a repair action is unknown, rather than providing a response with a repair action that has a low probability of success.

When there is a likely repair solution, the repair management program 126 may invoke the repair plan execution program 136 to determine and execute a repair plan 156 based on the likely repair solution. In some examples, the repair plan 156, or portion thereof, may be sent to the client computing device 110 that sent the repair request 150. Receipt of the repair plan 156 may cause the repair application 118 on the client computing device 110, such as the repairer computing device 112 in this example, to present the repair plan 156 on the repairer computing device 112 for viewing by one or more repairers 154, such as on a display associated with the repairer computing device 112. The repairer 154 may then perform the repair based on instructions included in the repair plan 156.

Alternatively, the repair plan execution program 136 may execute some portion of the repair plan 156, such as by sending a parts order 158 to the external computing device 145, scheduling a repairer for repairing the equipment, scheduling a time for the repair to be performed, or the like. For example, the external computing device 145 may be a web server or other suitable computing device including an external application 160 able to receive the parts order 158 and provide the repair part to a repairer 154 at a repair location, or the like. Further, the repair plan execution program 136 may provide repair instructions 162 to a client computing device 110, such as the repairer computing device 114 in this example. Receipt of the repair instructions 162 by the repair application 118 may cause the repair application 118 to present the repair instructions 162 on the repairer computing device 114 for viewing by the repairer 154. For example, a repairer may receive the repair instructions 162 in near real time while performing a repair at a repair site, such as at customer's home or the like.

In some examples, the repair instructions 162 may cause the equipment itself to perform a repair or otherwise initiate a repair. For example, the repair application 118 on the equipment computing device 116 may receive the repair instructions 162 and may perform one or more operations in accordance with the repair instructions 162 for performing the repair. Additionally, or alternatively, in some cases, the repair instructions 162 may include computer executable instructions that may be executed by the equipment computing device 116 for performing or otherwise initiating the repair. Accordingly, in some examples, the repair plan execution program 136 may initiate remotely a repair operation via the equipment computing device 116 for performing a repair on the corresponding equipment 152.

Following the repair, the repair application 118 may cause the client computing device 110 associated with a repair to send repair result information 170 to the repair management program 126. In response, the repair management program 126 may store the received result information as new data 172 in the historical repair data 108. The new data 172 may subsequently be used as part of the training data 142 for retraining the one or more machine learning models 140, thereby improving the operation of the one or more machine learning models 140. In addition, if the repair was unsuccessful, in some examples, the repair management program 126 may apply the result information 170 as a new repair request for determining a new or otherwise additional repair plan for the particular piece of equipment 152.

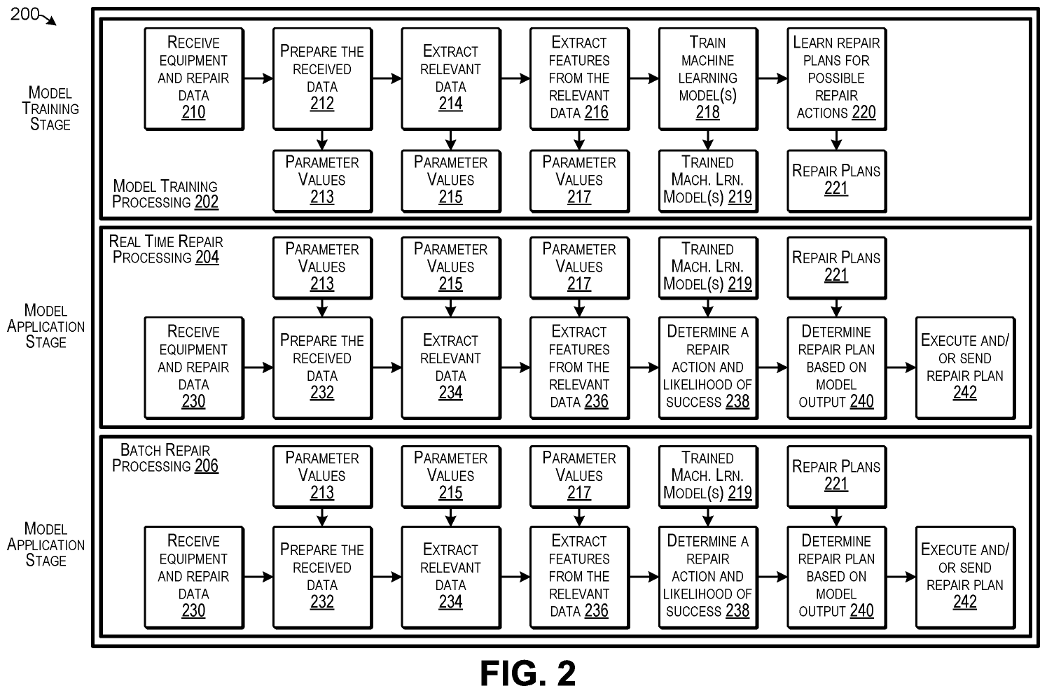

FIGS. 2, 8, and 9 are flow diagrams illustrating example processes according to some implementations. The processes are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, frameworks, and systems described in the examples herein, although the processes may be implemented in a wide variety of other environments, frameworks, and systems.

FIG. 2 includes three example flow diagrams 200 illustrating processes that may be executed by the repair management program 126 and other functional components discussed above with respect to FIG. 1 using the one or more processors of the service computing device 102. A first flow diagram 202 illustrates a process for model training, a second flow diagram 204 illustrates a process for real time repair processing during a model application stage, and a third flow diagram 206 illustrates a process for batch repair processing. The operations for real time processing and batch processing may be similar in many regards, and accordingly, only differences between the second flow diagram 204 and the third flow diagram 206 are described below.

As discussed above, initially the system may train one or more machine learning models using the historical repair data. For example, the repair data may have been received over time and stored in a database, or the like, for various repair incidents performed by repair personnel for the type or category of equipment for which the machine learning model(s) will be used. For example, if the machine learning model(s) will be used to determine repair plans for trucks, historical repair data for trucks may be accessed for training the machine learning model(s). Similarly, if the machine learning model(s) will be used to determine repair plans for refrigerators, a database of historical repair data for refrigerators may be used. In some examples, the historical repair data may be for a same brand of equipment and, in some cases, for a same model or model line of the equipment, depending on the availability of the historical repair data and the amount of the historical repair data. For instance, the historical repair data may be obtained from databases maintained by equipment manufacturers, equipment repair shops, or the like. Furthermore, in cases in which there is an insufficient amount of historical data for a particular brand or model of equipment, historical repair data for other brands and/or models of the equipment may be used in some cases depending on the similarities of the respective brands, equipment, or the like.

The training data obtained from the historical repair data and/or the data included in a repair request received from a client computing device may include or may be associated with a plurality of different types of data such as equipment attributes, equipment usage data, equipment sensor data, event data, user complaints and/or error messages, other complaint-related data, a repair history for the equipment and/or the equipment model, and various types of metadata.

The equipment attributes may be structured data that encodes the attributes of the equipment to be repaired. Examples of equipment attributes may include, but are not limited to, the make and model of the equipment, the manufacturing year of the equipment, and the capacity, ratings, or other quantifiable characteristics of the equipment and/or the equipment components. For the same symptoms, different types of equipment might require different repair actions. Therefore, equipment attributes are used during the model building process in order to learn the correct repair action for each equipment type when provided with given the symptoms of the failure.

The usage data may be structured data related to the usage of the equipment such as since the start of the service life of the equipment. Examples of usage data may include the age of the equipment, the number of hours, miles, operation cycles, etc., that the equipment has been operated, number/weight of payloads, and so forth. The usage data may be indicative of a cause of the failure, and may therefore be employed for determining the correct repair actions based on the symptoms of the failure.

The sensor data may be time series data collected from one or more sensors associated with the equipment before, during, or after the equipment was subject to failure. Each time series of data may represent the readings of the corresponding sensor over time. Furthermore, each sensor reading may be associated with a timestamp that may specify a time of the reading, such as a date and time of day.

The event data may indicate events associated with the equipment before the equipment failed or otherwise was requested to be repaired. Examples of events may be different types of maintenance actions, alarms, or the like. Each of the events may be associated with a timestamp that may specify a time of the event occurrence, such as a date and a time of day.

The user complaints and error messages may be natural language complaints received from the equipment user as well as any error messages, error codes, fault codes, or the like, received from the equipment or other systems in the environment of the equipment. The user complaints and error messages may be unstructured or semi-structured data that describe the symptoms of the failure that has been requested to be fixed (e.g., “loud noise from the back of the equipment”). User complaints may be submitted before or during the repair process, and may be received in a variety of different formats including but not limited to typed text, handwritten text, voice notes, voicemail, and the like.

The other complaint-related data may include other types of data that may contain more information about the failure to be repaired. Examples of this type of data may include images of defective parts, sound files from recording devices or ultrasonic monitoring devices, videos of the defective equipment or defective parts and so forth. This data may be submitted to the system before or during the repair process.

The repair history for the equipment may include historical repair incidents that have already been performed on the equipment for repairing previous failures. Each prior repair incident may have an associated timestamp that specifies a time at which the prior repair was performed, such as a date and time of day. In some examples, the repair history may also include attributes that describe different aspects of the repair incident, such as a system or subsystem of the equipment that was a source of the failure, one or more components that were replaced or repaired, the parts associated with the repair, and the actions that were performed for the repair such as replacing, cleaning, inspecting, and so forth.

The metadata may describe additional information about the environment in which the equipment is operated. The metadata may include but is not limited to the operating conditions e.g., operating hours, environment conditions such as location, temperature, humidity, and maintenance records such as date, condition of the equipment, operator notes, and the like. The metadata may appear in structured, semi structured, or unstructured formats.

As mentioned above, the computing device may initially train one or more machine learning models using the historical repair data. In this example, the model training processing 202 for training the machine learning model(s) begins at 210.

At 210, the computing device may receive equipment and repair data. For example, the computing device may receive historical repair data including any of the types of data discussed above such as equipment attributes, usage data, sensor data, event data, user complaint and error messages, other complaint-related data, repair history, and metadata.

At 212, the computing device may invoke the data preparation program to prepare the received data. For example, the data preparation program may be executed to remove noise from the received data and transform various different data types into one or more formats that may be used for further analysis. For example, for categorical and numerical data (such as equipment attributes and usage data) and time-series data (such as sensor data), the computing device may remove noise and outliers from the data and further may impute any missing data.

Noise and outlier removal may include detecting noise and outliers in the data values or the sensor readings and removing or replacing these data values with values calculated based on similar or nearby records or other readings of the same sensor (e.g., using an average or median of nearest neighbors). Furthermore, the noise removal may include the removal of noise due to data-entry errors and removal of repair mistakes or ineffective repairs. For example, repairs that did not result in solving the failure may be removed as not being of use for training the machine learning model. As one example, ineffective repairs may be detected by identifying equipment that was returned for repair with a similar complaint within a short time following a first repair. Additionally, as discussed below, ineffective repairs may also be identified explicitly by repairer feedback, and may be subsequently removed from the training data when the model is retrained.

Furthermore, imputation of missing data may include imputing missing values by interpolating values of similar or nearby records, or other readings of the sensor time series at nearby timestamps. In some cases, the imputation may be conducted using a regression model for the original time series and finding the values of the regression function at common timestamps, although other techniques will be apparent to those of skill in the art having the benefit of the disclosure herein.

In addition, the data preparation performed herein may include natural language data preparation of any received natural language data. As an example, for a user complaint, the computing device may initially convert the user complaint to a text format. For instance, if the user complaint is available as an image of a handwritten note, the system may employ an optical character recognition (OCR) algorithm to recognize the text of the user complaint. Alternatively, if the user complaint is available as a voice note, the computing device may employ a speech-to-text algorithm to convert the speech signal into a natural-language text.

After the text of the user complaint is extracted, the extracted text may be cleaned, such as by removing special characters, removing stop words, normalizing abbreviations, normalizing synonyms, correcting typos, and performing stemming For example, special characters (e.g. “;”, “#”, “!”, “@”), may be removed from the input text, and the text may further be tokenized into words (tokens), such as in lower case letters. Furthermore, domain-specific tokens may be normalized to a unified format (e.g., error codes “1234/567” and “1234567” may be normalized to a consistent format, and measurements such as “30 mph” and “30 mph” may be similarly normalized). Additionally, stop word removal includes the removal of common words that do not add useful information to the problem description (e.g., “in”, “a”, “of”, “the”, “is”). This step might utilize a general purpose or domain-specific list of stop-words. Furthermore, normalization of abbreviations may expand and normalize abbreviations encountered in the text, such as by changing “cel” to “check engine light”, etc. In addition, synonyms may be normalized to a selected term by identifying and normalizing pairs of synonyms in the domains. Further, text correction may include detecting and correcting typos in the text, such changing “leek” to “leak” and so forth. Finally, stemming may include converting all words to their stem to reduce the lexical variations in the input text (e.g., “leaked”, “leaking” and “leaks” may all be converted to the stem “leak”). The aforementioned cleaning steps can also be applied to other data types that include unstructured text, such as error messages from computer systems inside the equipment or in the environment of the equipment. Additionally, for other data types, such as images, sound files, or video files, standard data cleaning and preparation techniques may be applied, as is known in the art. Furthermore, parameter values 213 used by the data preparation program for preparing the training data may be logged and used subsequently by the data preparation program when preparing data received with a repair request during the model application stage as discussed additionally below.

At 214, the computing device may invoke the relevant data extraction program to extract relevant data from the prepared data. For example, this operation may include extracting segments of data that are related to the repair at hand. Given the time of failure t_{f}, the following data segments may be extracted:

(a) Equipment attributes: the computing device may extract all the attributes of the equipment subject to repair.

(b) Usage data: the computing device may extract the usage data at the time of the failure t_{f}. If usage data is not available at that time, the computing device may extrapolate the latest usage data to estimate the usage at t_{f}.

(c) Sensor data: the computing device may extract all sensor measurements within a first threshold time period T₁ before the time of failure t_{f}.

(d) Event data: the computing device may extract all events within a second threshold time period T₂ before the time of failure t_{f}.

(e) User complaint and error messages: the computing device may use all natural-language complaints and error messages generated before the failure, or following the failure during the repair process.

(f) Other complaint-related data: the computing device may extract all data files generated before or during the repair process.

(g) Repair history: for training data, the computing device may extract all the details of prior repair processes (e.g., system(s), subsystem(s), component(s), part(s), and repair action(s) performed), and use these details as the target labels that are to be learned by the machine learning model. For each training or new repair incident, the computing device may extract the sequence of the latest k repairs, and use them to extract features, as discussed additionally below, that can be used to determine a repair action to be performed for repairing a current failure.

(h) Metadata: for time-varying data, the computing device may extract only data instances within a third threshold time period T₃ before the time of failure t_{f}. For static data, the computing device may extract all the attributes related to the equipment or environment. Furthermore, parameter values 215 used by the relevant data extraction program for extracting the training data may be logged and used subsequently by the relevant data extraction program when extracting data from data received with a repair request during the model application stage as discussed additionally below.

At 216, the computing device may invoke the feature extraction program to perform feature extraction from the extracted data. For example, given the variables that were extracted during the relevant data extraction operation discussed above, the computing device may extract features for each variable, such as time-varying variables (e.g., window-level statistics, trends, correlations, and sequential patterns), static variable, and free text variables. The result of the feature extraction may provide a set of binary, categorical, and numerical features. One approach to combine all these types of features includes converting all numerical features into intervals and then using one-hot encoding to convert categorical variables and intervals extracted from numerical variables into binary variables. Other techniques may alternatively be applied to combine features of different types, as will be apparent to those of skill in the art having the benefit of the disclosure herein.

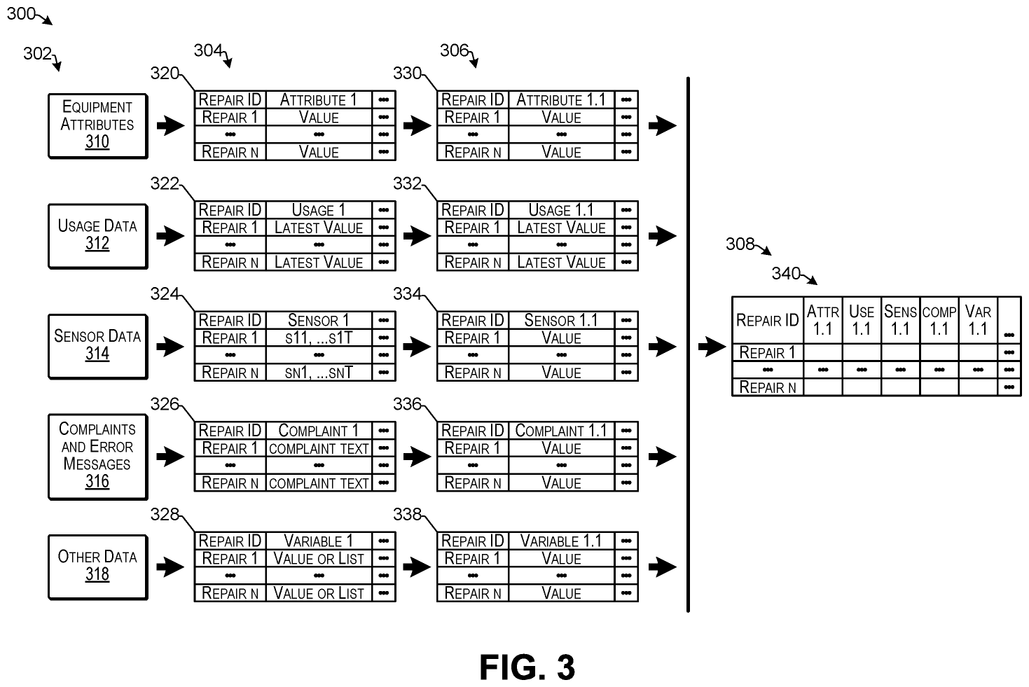

The set of features extracted by the computing device may be transformed to a single vector for each repair incident. For training data, the features may be combined into an n×m feature matrix X where the (i, j)-th element represents the value of feature j for repair i, where n is the number of features and m is the number of repair incidents. Additional details of the feature extraction are discussed below with respect to FIG. 3. Furthermore, parameter values 217 used by the feature extraction program for extracting the features from the training data may be logged and used subsequently by the feature extraction program when extracting features from data received with a repair request during the model application stage, as discussed additionally below.

At 218, the computing device may train the machine learning model(s) using the extracted features. For instance, to recommend repair actions, a machine learning model, such as a multi-label classifier may be trained to map between the extracted features and the corresponding repair actions. Examples of classification models may include random forest, support vector machines, or deep neural networks. Other types of machine learning models may additionally, or alternatively, be used, as enumerated elsewhere herein.

The trained machine learning model(s) 219 may be configured to output one or more options for repair actions that may be performed to repair the failure of the equipment along with a probability of success for each output repair action. The probably of success may indicate a likelihood that the repair action will successfully repair a current failure based on the historical repair data. Techniques for training machine learning models are well known in the art and are not described in detail herein.

At 220, the computing device may learn or otherwise determine repair plans 221 corresponding to the possible repair actions that may be output by the trained machine learning model(s) 219. For example, during the model training stage, the repair plan execution program may learn from the historical repair data, or other sources, the steps taken for implementing each different repair action that may be determined by the machine learning model. For example, for each repair action that may be a possible outcome of a machine learning model, the repair plan execution program may obtain, e.g., from the extracted data or other data sources, the repair steps that are indicted to be used for performing the repair. Additionally, in some cases, the repair plan execution program may access other data sources, such as an equipment repair manual from the equipment manufacturer, to obtain the repair steps for each possible repair action that may be output by the machine learning model.

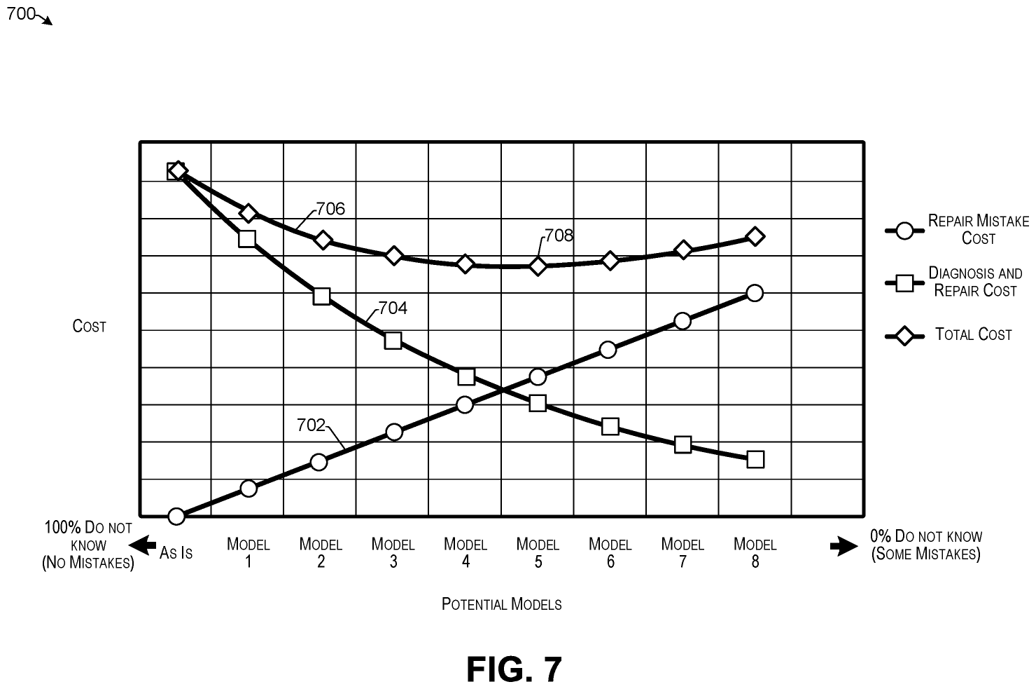

Based on the learned repair steps for each repair action, subsequently, during the model application stage, the repair plan execution program may, in some examples, execute one or more of the aforementioned steps using the learned repair plan. Further, in the case that there are multiple repair options for a particular failure, the repair plan execution program may select one of the options so that the overall repair cost may be minimized, and the availability of the equipment may be maximized The information about the impact of each repair action (cost and time) may be obtained from external sources or from the historical repair data. An example of considering the impact of the individual repair actions is discussed below with respect to FIG. 7. Accordingly, the repair plan execution program may configure the service computing device to generate one or more repair plans 221 based on one or more outputted repair actions output by the machine learning model(s).

Following training of the machine learning model(s) and following configuration of the repair plan execution program to generate repair plans for the possible repair actions that may be recommended by the machine learning model, the system is ready to execute at the model application stage for either real time processing and as indicated at 204 or batch processing as indicated at 206. As mentioned above, these processes are similar. For instance, the real time processing may take place as the request for repair is communicated to the service computing device, whereas the batch processing may take place after the fact, i.e., at some time (minutes, hours, days) after the repair request has been sent to the service computing device.

At 230, the computing device may receive equipment and repair data, such as in a repair request from a client computing device, e.g., as discussed above with respect to FIG. 1. Further, the computing device may also receive some equipment and repair data relative to the particular equipment from the historical repair data or other sources. For example, the equipment attributes, the usage data, the event data, and the repair history may be obtained from the historical repair data or other sources.

At 232, the computing device may prepare the received data corresponding to the repair request. For example, the computing device may invoke the data preparation program to remove noise from the received data, normalize the received data, and transform various different data types into one or more formats that can be used for further analysis, as discussed above at 212. The parameter values 213 used during the training stage may be used to prepare the received data. Further, in some cases, the operations 232-240 may be the same for the real time stage 204 and the batch stage 206. However, in other cases the operations 232-240 executed during the batch repair processing stage 206 may differ from the operations 232-240 executed during the real time repair processing stage 204. For example, although the respective operations 232-240 may perform the same function in each stage 204 or 206, the processing steps may be different, such as due to a difference in the nature of the received data 230 to be prepared at 232.

As one example, when determining repairs to recommend for a batch of input cases, some implementations may construct all of the features in parallel, pass a feature matrix which contains all the features for all the input cases, and run a parallel program to multiply this feature matrix with the weights of the model to determine the repair with the highest probability of success for each case. On the other hand, when performing real time data processing, the same operations may be performed using a single vector of features for the case at hand. Accordingly, the algorithm logic may be the same, but the implementation code may be different, e.g., for implementing matrix operations on parallel machines during batch mode as compared with using vector multiplication on a single machine for the real time mode. In some cases, the same code may be used for both batch mode and real time mode, such as by making the real time operation a special case of the batch operation. In other cases, separate code may be employed for the real-time case and the batch case. Further, other variations will be apparent to those of skill in the art having the benefit of the disclosure herein.

At 234, the computing device may extract relevant data from the prepared data. For example, the computing device may invoke the relevant data extraction program to extract relevant data as discussed above at 214. The parameter values 215 used during the training stage may be used to extract relevant data such as equipment attributes, usage data, sensor data, event data user complaints and error messages, other complaint-related data, repair history, and metadata.

At 236, the computing device may extract features from the extracted relevant data. For example, the computing device may invoke the feature extraction program to extract features from the relevant data, as discussed above at 216. The parameter values 217 used during the training stage may be used to extract features for each variable, such as time-varying variables (e.g., window-level statistics, trends, correlations, and sequential patterns), static variable, and free text variables.

At 238, the computing device may determine a repair action and likelihood of success. For example, the computing device may invoke the model building and application program to input the extracted features into the trained machine learning model(s) 219. The trained machine learning model(s) 219 may be executed using the extracted features as inputs to determine, as outputs of the trained machine learning model(s), one or more repair actions and a probability of success of each of the repair actions.

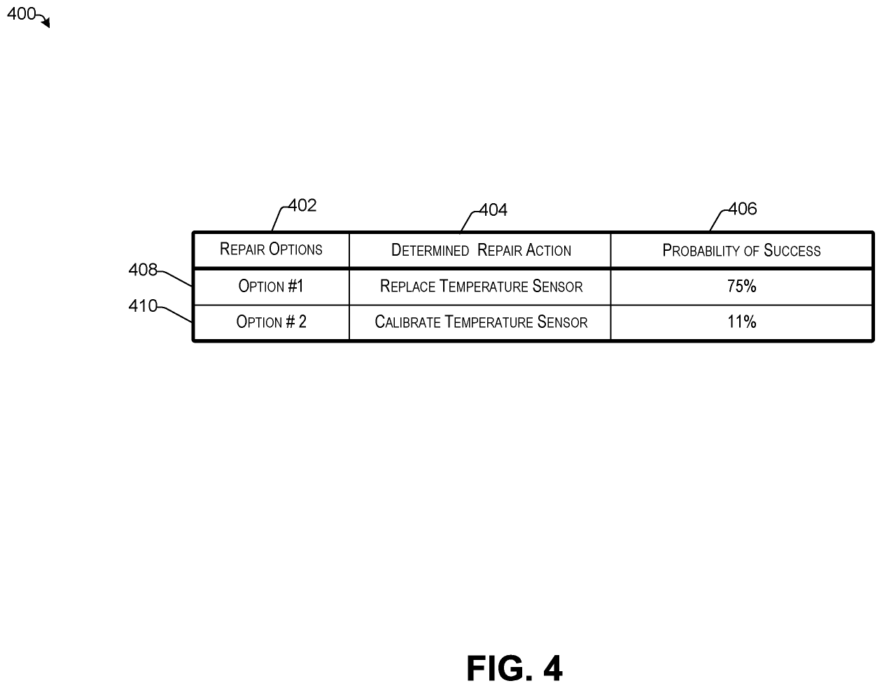

At 240, the computing device may determine a repair plan based on the model output. For example, the computing device may invoke the repair plan execution program to determine one or more repair plans based on the output of the trained machine learning model. As mentioned above, the repair plan execution program may select one or more repair plans 221 determined, e.g., from historical records or the like, as described above at 220, for implementing the repair action determined by the trained machine learning model. If there are multiple options for repair actions, the repair plan execution program may be configured to select the repair action(s) that are indicated to have the higher probability of success. Furthermore, if the probability of success for all of the determined repair actions received from the trained machine learning model(s) are below a threshold probability of success, the repair plan execution program may perform an analysis to determine whether it is more beneficial to recommend one of the repair actions or send an indication that the repair action is unknown. The determination may be based on whether the overall maintenance cost is minimized, and the availability of the equipment is maximized Additional details of performing this analysis are discussed below with respect to FIGS. 4 and 7. The information about the impact of each repair step (e.g., cost and time) could be obtained from external data sources, domain knowledge, and/or learned from historical repair records.

At 242, the computing device may execute and/or send the repair plan or a portion of the repair plan to a client computing device associated with the received repair request. In some examples, the repair plan execution program may execute at least a portion of the repair plan to implement the repair action determined by the machine learning model. For instance, executing the repair plan may include, but is not limited to, ordering replacement parts for performing the repair, assigning a repairer to perform the repair, scheduling a repair time for repairing the equipment, and/or remotely applying a repair to the equipment, such as in the case of an automatic diagnosis, changing operating conditions of the equipment, performing a remote firmware upgrade, remotely adjusting settings of the equipment, remotely initiating cleaning of the equipment, remotely initiating calibration of the equipment, and so forth. Furthermore, in some examples, the repair plan execution program may send instructions to the repairer computing device for presentation on the repairer computing device. Additionally, in still other examples, the repair plan execution program may send instructions to the equipment itself, such as to the equipment computing device, which may then perform or otherwise initiate the repair independently based on the received instructions. Numerous other variations will be apparent to those of skill in the art having the benefit of the disclosure herein.

FIG. 3 illustrates an example 300 of extracting relevant data and relevant data features according to some implementations. For example, the techniques described herein may be applied during operations 214-216 and/or 234-236 discussed above with respect to FIG. 2. Accordingly, for the various different types of data 302, the relevant data may be extracted as indicated at 304. Furthermore, the relevant features may be extracted from the relevant data, as indicated at 306, which results in a set of binary, categorical, and numerical features. One approach for combining all these types of features is to convert all numerical features into intervals and then use one-hot encoding to convert categorical variables and intervals extracted from numerical variables into binary variables. However, other techniques may alternatively be applied to combine features of different types, as will be apparent to those of skill in the art having the benefit of the disclosure herein.

The set of extracted features 306 may be transformed to a single vector for each repair identifier (ID). For training data, the features 306 may be combined into an n×m feature matrix 308 where the (i, j)-th element represents the value of feature j for repair i, and where n is the number of features and m is the number of repairs.

In this example, the data 302 includes equipment attributes 310, usage data 312, sensor data 314, complaints and error messages 316, and other data 318. The equipment attributes 310 typically may be values that are unchanged throughout the life of the equipment, and, as indicated at 320, may be extracted as a plurality of attribute values corresponding to a plurality of repairs 1−n. Similarly, for the usage data 312, a plurality of latest usage values may be extracted for each repair as indicated at 322. Furthermore, for the sensor data 314, a plurality of sensor readings may be extracted for each repair ID for each sensor associated with the equipment as indicated at 324. Additionally, for the complaints and error messages 316, the complaint text and/or error messages for each repair ID may be extracted as indicated at 326. In addition, for the other data 318, variable values and/or lists may be extracted for each other-data variable, as indicated at 328.

Subsequently, as indicated at 306, given the variables at 304 that were extracted during the relevant data extraction operation, the feature extraction program may extract features for each variable. As indicated at 330, the values for the attributes may be static variables. Static variables may have a single value associated with the respective repair. In this case, the variable may be used as is. Furthermore, for the usage data 312, the latest value of the usage may be extracted for each repair ID, as indicated at 332.

With respect to the sensor data 306, for time-varying variables such as when there are multiple values (categorical or numerical) associated with the repair action (e.g., temperature measurements for one week before the failure), then given a set of values over time S={s1(t), s2(t), . . . , sk(t)}, and a time window {t1, t2}, the feature extraction program may extract all the values within this time window and then extract a group of features to be provided to the recommendation model as indicated at 334. These features may include, but are not limited to window-level statistics, trends, correlations, sequential patterns, and so forth. For example, for window-level statistics, the feature extraction program may calculate, for each variable, a statistic over all the values within a selected window (e.g., minimum, maximum, average, median of events, frequency of events, and so forth). As another example for trends, the feature extraction program may quantify, for each variable a trend of the values within the window (e.g., increasing, decreasing, constant, slope of increase/decrease, etc.). Furthermore, for correlations, the feature extraction program may detect and quantify correlations between multiple variables within the time window. In addition, for sequential patterns, the feature extraction program may extract sequential patterns of values, and define a feature for each pattern. Numerous other variations will be apparent to those of skill in the art having the benefit of the disclosure herein.

As mentioned above, the complaints and error messages 316 may include free text as well as error codes or the like. Values may be assigned to the free text, as indicated at 336, based on various free text weighting schemes. As one example, for each free-text variable, the feature extraction program may extract all the n-grams inside the text (for n=1, 2, . . . , k), and may then define a feature for each n-gram and assign a weight for this n-gram within a larger free-text phrase or sentence. The assigned weight may be a binary indicator that is equal to 1 if the particular n-gram appears inside the free-text variable or may represent the frequency of the n-gram inside the free-text. More intricate weighting schemes may also be employed. For instance, if the user complaint text is “warning light on”, the unigrams, bigrams and trigrams extracted from this complaint may correspond to {“warning”, “light”, “on”, “warning light”, “light on”, “warning light on”}, with the trigram being most heavily weighted.

Additionally, the other data may include variables for which values may be assigned as indicated at 338, such as using the techniques discussed above with dispensed to the sensor data, or the other data types discussed above, depending on the nature of the other data. As mentioned above, the output of the feature extraction program is a set of binary, categorical and numerical features. The numerical features may be converted into intervals and one-hot encoding or other techniques may be used to convert categorical variables and intervals extracted from numerical variables into binary variables. The set of features extracted during this step may then be organized as single vector for each repair ID (corresponding to a repair incident) as indicated at 340. For training data, the features may be combined into the feature matrix 308, as described above.

As one example, the feature extraction program may receive historical repair data for equipment, and may identify free-form text in the historical repair data by extracting words, phrases, topics, sentences, and other free-form text. The feature extraction program may determine one or more n-grams from the free-form text and may define at least one feature for the free-form text based on assigning one or more values to the one or more n-grams. The feature extraction program may further extract a plurality of other features from the historical repair data. As discussed additionally elsewhere herein, the model building and application program may train at least one machine learning model using the at least one feature and the plurality of other features. Subsequently, when the system receives a repair request associated with the equipment, the model building and application program may use the at least one trained machine learning model to determine one or more repair actions based on the received repair request. In some cases, the system may determine a plurality of possible repair actions that may be outputted by the one or more machine learning models, and may determine, from the historical repair data, respective repair plans corresponding to individual ones of the plurality of repair actions. For instance, each repair plan may include repair information for performing an associated repair on the equipment. In addition, the extracting of the plurality of other features from the historical repair data may include, for individual ones of repair incidents identified in the historical repair data, associating a respective feature vector from the extracted features corresponding to the individual repair incidents.

FIG. 4 illustrates an example output 400 received from a trained machine learning model according to some implementations. As mentioned above, for determining repair actions for responding to a current repair request, the machine learning model is initially trained to map between the extracted features and corresponding repair actions. The output 400 of the trained machine learning model may include one or more options of repair actions that may be performed to fix the failure of the equipment along with a probability of success for each repair action. The probably of success reflects the machine learning model's determination, based on the historical repair data, of the likelihood that the repair action will repair the failure corresponding to the repair request.

In this example, the output 400 includes repair options 402, determined repair action 404, and probability of success 406. For example, as indicated at 408, a first repair option includes replacing the temperature sensor, which has a probability of success of 75 percent. As indicated at 410, a second repair option determined by the machine learning model is to calibrate the temperature sensor, which has a probability of success of 11 percent. As mentioned above, the repair plan execution program may receive the output 400, and may formulate a repair plan based on the output 400. For instance, in this example, since the probability of success of the first option is significantly better than the probability of success of the second option, the repair plan execution program may compose a repair plan based on the first option and may execute the repair plan or a portion thereof, and/or send the repair plan to a repairer computing device, and/or perform other actions, as discussed above.

In some cases, the repair plan execution program may further consider other factors in addition to, or as an alternative to, the probability of success 406. For example, the repair plan execution program may consider the time and/or cost of repair when determining a repair plan. For example, suppose that calibration of the temperature sensor (option #2) may be accomplished substantially more quickly or more cheaply than replacement of the temperature sensor (option #1). Accordingly, by considering time, cost, or other factors, the repair plan execution program may be configured to instruct performance of the calibration first, despite the lower probability of success, and then testing the equipment to determine whether the problem has been corrected. If the problem is not corrected by the calibration, the repair plan execution program may be configured to then instruct replacement of the temperature sensor.

In some examples, one or more thresholds may be applied to the factors to enable the repair plan execution program to determine a repair plan. For instance, if the time or cost of attempting the second option is less than half the time or cost of the first option, the repair plan execution program may instruct performance of the second option. Otherwise, if the time or cost savings would be minimal, i.e., the time and/or cost of the first option is greater than the respective threshold, the repair plan execution program may simply instruct performance of the first option, which has a greater probability of success. The time or cost of each repair may be determined from the historical repair data and/or may be determined from the domain knowledge for the equipment.

As illustrated in FIG. 4, an output of the at least one trained machine learning model includes one or more repair actions and a respective probability of success associated with each repair action. The repair plan execution program may be executed by the system to further determine a repair plan based on the one or more repair actions 404 in the output 400 and the respective probability of success 406. Based on the determined repair plan, the repair plan execution program may perform at least one of: sending an order for a part for a repair; sending a communication to assign labor to perform the repair; sending a communication to schedule a repair time for the repair; or remotely initiating a procedure on the equipment to effectuate, at least partially, the repair. Additionally, or alternatively, based on the one or more repair actions, the repair plan execution program may send repair information to a computing device associated with the equipment in response to receiving a repair request. For example, the repair information may cause an application on the computing device associated with the equipment to present the repair information on the computing device. Additionally, or alternatively, based on the one or more repair actions, the repair plan execution program may send repair information to an equipment computing device, such as an embedded computing device or other client computing device involved in the operation of the equipment. For example, the repair information may cause the equipment computing device to initiate at least one of the repair actions on the equipment. In some cases, if the probability of success associated with the one or more repair actions is below a threshold probability, the system may send an indication to a computing device associated with the repair request that a repair is unknown.

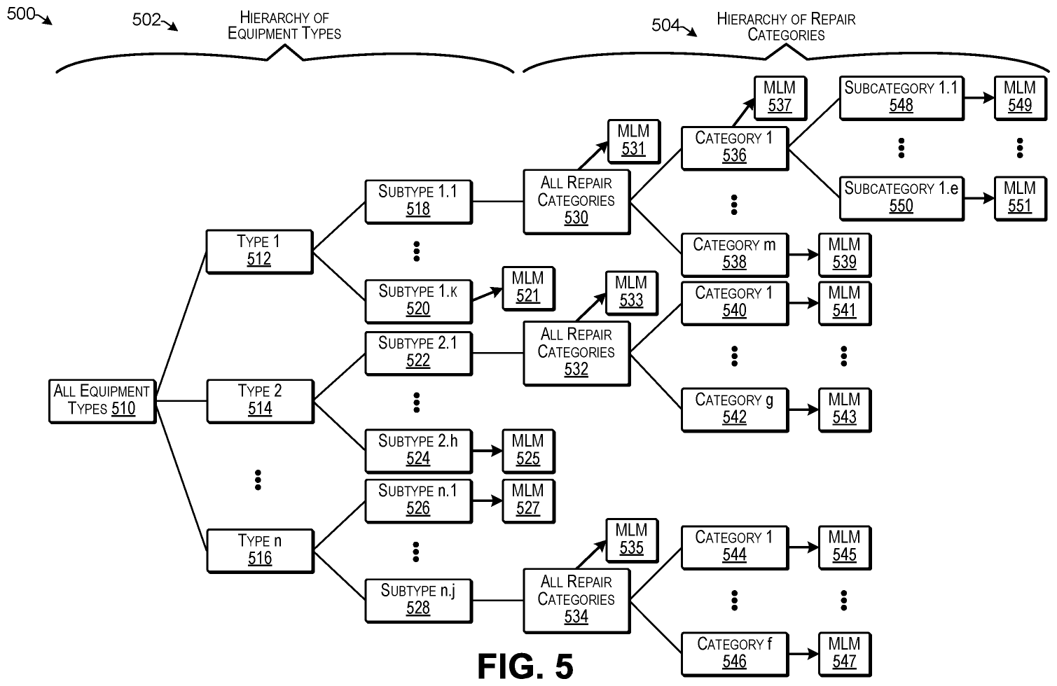

FIG. 5 illustrates an example hierarchical data structure 500 and corresponding hierarchy of machine learning models according to some implementations. The hierarchical data structure 500, such as a tree having a plurality of nodes, may be used to enable the system to process more efficiently the large amounts of possible variables for complex equipment that may have a large number of different types of repair actions. For example, for complex equipment, such as vehicles or the like, with a variety of models and a large number of components, the number of repair actions that may be performed can be very large (e.g., thousands of possible repair actions). This large number of possible repair actions can make it very difficult to train a single machine learning model able to differentiate between all possible repair actions in a single step. In order to solve this problem, the system herein builds a hierarchy of machine learning models to determine repair actions. The model building and application program may generate the hierarchical data structure 500, and may also generate a corresponding hierarchy of machine learning models (MLMs) that are related to each other in a hierarchical relationship based at least partially on the hierarchical data structure 500.

In this example, the hierarchical data structure 500 includes a first hierarchy of equipment types 502 and a second hierarchy 504 of repair categories. The hierarchical data structure 500 may be constructed in two steps by first building the first hierarchy 502 of equipment types and then building the second hierarchy 504 of repair categories. The second hierarchy 504 may stem from individual leaf nodes of the first hierarchy 502 of equipment types when the number of repair actions for an individual leaf node of the hierarchy 502 of equipment types is still larger than a threshold number of repair actions. For example, the threshold number may be determined based on the type of machine learning model being used, the desired processing speed of the machine learning models, or the like.

In examples herein, a leaf node may be a node at the lowest level of its respective hierarchy such that the leaf node does not have any other lower nodes in the same hierarchy extending or otherwise branching therefrom. At least one or more leaf nodes in the first hierarchy will have nodes in the second hierarchy extending therefrom. When the model building and application program splits the data into additional nodes, the model building and application program may determine how many unique repairs are associated with each new node, e.g., from the historical repair data and/or domain knowledge. During testing of the machine learning models, if the node criteria depends on input data, the model building and application program can traverse the hierarchy based on the values of the input data. If the node criteria depends on the output of a machine learning model, the model building and application program may apply the model first and based on the output for traversing the hierarchy.

In some examples, the model building and application program may receive domain knowledge related to the equipment that may be used for generating the hierarchical data structure 500 and associated hierarchy of machine learning models. In the examples herein, the domain knowledge is knowledge about the equipment and the environment in which the equipment operates. Domain knowledge may be learned from the historical repair data or other information about the equipment, which may be obtained from the one or more data sources 104 and/or the external computing devices 145 discussed above with respect to FIG. 1. The domain knowledge may include equipment attributes such as manufacturer or brand information, equipment model, model year, trim levels, options, capacities, service environments, and so forth. Accordingly, the domain knowledge is information about the particular equipment that may be used to classify the equipment into smaller groups of equipment that share one or more selected attributes. In some cases, the hierarchy may be generated using the historical repair data at the domain knowledge when the historical repair data includes sufficient details about the equipment types, subtypes, or other equipment categories.

Using at least one of the historical repair data and/or received domain knowledge, the model building and application program may initially divide the equipment into groups of equipment types based on the attributes of the equipment (e.g., make, model, capacity) such that the number of possible repair actions for each group becomes smaller. In this case, a machine learning model may be trained for each group at the leaf nodes of the hierarchical data structure 500 that have a number of possible repair actions that are less than a threshold number. On the other hand, if a node is not a leaf node in the first hierarchy, then a machine learning model might not be trained for that node.

For instance, in the illustrated example, the equipment root node 510 is for all equipment types, a first layer of nodes divides the equipment types into a plurality of different equipment types 512, 514, and 516, and a next layer of nodes divides the equipment types into a plurality of different equipment leaf node groups based on equipment subtypes 518, 520, 522, 524, 526, and 528. As a non-limiting example, suppose that the node 510 corresponds to a make of a vehicle, node 512 corresponds to a model of the vehicle, and node 518 corresponds to a model year of the vehicle, or the like.

In this example, suppose that the number of possible repair actions for the equipment leaf nodes 520 524 and 526 is below the threshold number. Accordingly, a respective machine learning model (MLM) 521 may be trained for the leaf node group 520, a respective machine learning model 525 may be trained for the leaf node group 524, and a respective machine learning model 527 may be trained for the leaf node group 526. In some examples, the model training stage of FIG. 2 may be executed for each MLM trained for the hierarchical data structure 500.

Furthermore, for those equipment leaf node groups (i.e., corresponding to equipment leaf nodes 518, 522, and 528 in this example) having a number of possible repair actions that are still greater than the threshold number, the model building and application program may associate the hierarchy 504 of repair categories with those leaf node groups. Accordingly, for each equipment leaf node group 518, 522, and 528, for which the number of repair actions still exceeds the threshold number, the model building and application program may divide the repair categories for this equipment subtype into the second hierarchy 504 of repair categories until the number of possible repair actions for each repair leaf node group is smaller, e.g., below the threshold number of possible repair actions.

In the illustrated example, the model building and application program creates a node 530 representing all repair categories for the equipment subtype 1.1 of node 518, a node 532 representing all repair categories for the equipment subtype 2.1 of node 522, and a node 534 representing all repair categories for the equipment subtype n.j of node 528. Each of these nodes 530, 532, and 534 may be further divided into repair categories as indicated at nodes 536, 538, 540, 542, 544, 546. Furthermore, suppose that repair category 1 at node 536 is further divided into subcategories as indicated at nodes 548 and 550. Furthermore, suppose that each of the repair category leaf nodes 538, 540, 542, 544, 546, 548, and 550 correspond to repair leaf node groups in which a number of repair actions is less than the threshold number of possible repair actions. As a non-limiting example, suppose that category 1 at node 536 is for engine repairs, category m at node 538 is for suspension system repairs, and so forth, and that subcategory 1.1 at node 548 is for ignition system repairs, subcategory 1.e at node 550 is for fuel system repairs, and so forth.

For the second hierarchy 504 of repair categories, a respective machine learning model may be generated for each of the nodes in the second hierarchy, regardless of whether the node is a leaf node or not. Accordingly, the model building and application program may train a respective machine learning model (MLM) 531, 533, 535, 537, 539, 541, 543, 545, 547, 549, and 551 for the respective repair category nodes 530, 532, 534, 536, 538, 540, 542, 544, 546, 548, and 550.

Subsequently, following training of the machine learning models 521, 525, 527, 531, 533, 535, 537, 539, 541, 543, 545, 547, 549, and 551 in the hierarchical arrangement corresponding to the data structure 500, when a new repair request is received for an equipment, the equipment is associated with a single equipment leaf node group in the hierarchical data structure 500 based on matching the attributes of the equipment for which the repair is requested with the equipment leaf node groups. If the matching equipment leaf node is an equipment leaf node, such as one of leaf nodes 520, 524, or 526, the model building and application program may use the associated machine learning model, i.e., 521, 525, or 527, respectively, for determining a repair action. On the other hand, if there is a hierarchy of repair categories associated with the matching equipment leaf node, the model building and application program invokes the machine learning model at each level of the hierarchy 504 of repair categories until a leaf node is reached. At this repair category leaf node, a more specific repair action may be determined for responding to the repair request. For instance, if the matching equipment leaf node is node 530, the model building and application program invokes the machine learning model 531, which may indicate that repair category m is appropriate (corresponding to node 538). Accordingly, the model building and application program invokes the machine learning model 539 to determine one or more repair actions for the equipment.

Thus, upon receiving a repair request, the model building and application program may traverse the first hierarchy until a leaf node of the first hierarchy is reached. If there are second hierarchy nodes extending from the leaf node of the first hierarchy, the machine learning models of the second hierarchy nodes are used until a leaf node of the second hierarchy is reached. On the other hand, if there are no second hierarchy nodes extending from the leaf node of the first hierarchy, the machine learning model associated with the leaf node of the first hierarchy is used.

In some examples, the hierarchies may be determined using domain knowledge or may be constructed from the historical repair data by searching in the space of all possible hierarchies such that the number of repair options in each node of the hierarchy becomes smaller than the threshold number, and similarities between different groups of equipment and/or repairs are minimized

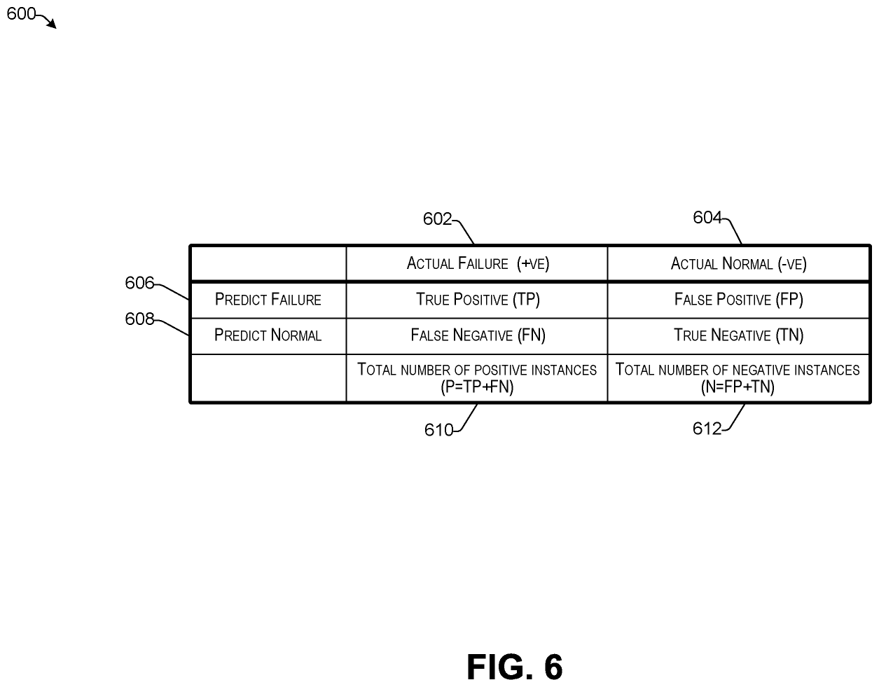

FIG. 6 illustrates an example confusion matrix 600 that may be used to calculate machine learning model performance measures according to some implementations. In some examples, the model building and application program may be executed to perform this function. After the one or more machine learning models are trained using the historical repair data, the machine learning model(s) may be deployed for determining repair actions in response to receiving repair requests for equipment in need of repair. The performance of the machine learning model(s) during the deployment time can be estimated using k-fold cross-validation. In k-fold cross-validation, the training data is split into k folds. The machine learning model is then trained on (k−1) folds and tested using the remaining k-th fold. This process is repeated k times for the k folds and the resulting recommendation labels (i.e., the output repair actions) are compared to the ground-truth labels (i.e., the actual repairs performed by repairers in the past) to estimate the performance (accuracy) of the particular model.

Several measures can be used to estimate the performance of the model. To calculate these measures, the confusion matrix 600 may be constructed for each type of repair action R that may be produced by the respective machine learning model. The confusion matrix 600 may be constructed by counting the number of actual repair actions of type R that are correctly and wrongfully recommended as R, i.e., true positive (TP) and false negative (FN), respectively. Further, the confusion matrix 600 may be constructed by counting the number of repairs of other types of repair actions that are correctly and wrongfully classified as type R, i.e., true negative (TN) and false positive (FP), respectively.

As illustrated in FIG. 6, the confusion matrix 600 includes actual failure 602, actual normal 604, predict failure 606, and predict normal 608. Accordingly, the true positive (TP) corresponds to 602 and 606; false positive (FP) corresponds to 604 and 606; false negative (FN) corresponds to 602 and 608; and true negative (TN) corresponds to 604 and 608. Furthermore, the total number of positive instances is indicated at 610 and the total number of negative instances is indicated at 612.

Several performance measures may be derived from the confusion matrix, such as recall or true positive rate, false alarm rate, and precision, as discussed below.

Recall or True Positive Rate=TP/P=TP/(TP+FN): This is the percentage of actual repairs of type R correctly classified by the model.

False Alarm Rate=FP/N=FP/(FP+TN): This is the percentage of repairs of other types wrongfully classified by the model as type R.

Precision=TP/(TP+FP): This is the percentage of repairs classified by the model as type R whose true repair type is R.

Typically, a combination of e.g., (recall and precision) or (recall and false alarm rate) may be used to describe the performance of a machine learning model. There are multiple parameters of the model that may be selected during the training of each machine learning model. Using the techniques discussed above, for determining the accuracy of the machine learning models herein, these parameters may be tuned to maximize the model performance

FIG. 7 illustrates an example graph 700 for determining which machine learning model to employ according to some implementations. For example, as discussed above with respect to FIG. 4, a machine learning model herein may generate a plurality of different options for repair actions, each of which may be associated with a probability of success. If the probability of success is very low for some of the options, the repair plan execution program may not show these options to the repairer so that the repairer may focus on the repair actions that are likely to result in success.

Furthermore, if all of the repair options have a very low probability of success, the repair plan execution program may report or otherwise indicate that there is no repair action that can be determined given the input data included in the repair request. This is referred to as a “do not know” response in some examples herein. For instance, a repairer may waste considerable time and resources attempting to perform ineffective repairs when there is a low probability of success for all of the repair actions. Accordingly, reporting an indication of a “do not know” response for repairs with very low probability of success will result in fewer repair mistakes, but will also reduce the benefit of the repair determination system disclosed herein.

In some examples herein, the number of “do not know” responses may be optimized by controlling a trade-off between a cost of providing mistaken instruction to the repairer and a cost savings achieved by providing a correct instruction. In order to achieve this optimization, the model building and application program may apply the model performance evaluation discussed above with respect to FIG. 6 along with information about the cost of mistakes of different repairs as well as the cost savings achieved by instructing repair actions (e.g., saving in diagnosis time). For different numbers of “do not know” responses, the model building and application program may generate different machine learning models and may estimate for each machine learning model the overall cost savings achieved by this machine learning model. The model building and application program may determine one of the machine learning models that achieves a maximum optimization between cost of mistakes and cost savings, and may select this machine learning model for deployment.

The graph 700 includes a first curve 702 that shows an increase in repair mistake cost as the number of repair mistakes increases for a plurality of differently configured machine learning models 1-8, as represented along a bottom axis of the graph 700. For instance, the different machine learning models 1-8 may be configured to return “do not know” responses at different thresholds of probability of success for respective repair actions. The repair mistake cost 702 may represent the cost associated with using each machine learning model 1-8 given the number of mistakes expected to be provided by that respective machine learning model, as well as the number of correct repairs expected to be identified by that machine learning model. Furthermore, the graph 700 includes a second curve 704 that shows a decrease in diagnosis and repair cost for each selected repair action that is performed. As correct repairs are made, the cost of diagnosis and repair 704 may be offset. Thus, the graph 700 includes a third curve 706 that is a sum of the first curve 702 and second curve 704 showing the total cost associated with operating each model at a different threshold for providing “do not know” responses. As indicated at 708, the optimal machine learning model is the illustrated example is model 5; however, different models may be selected in different examples based on the performance determined for each model, as discussed above, e.g., with respect to FIG. 6.

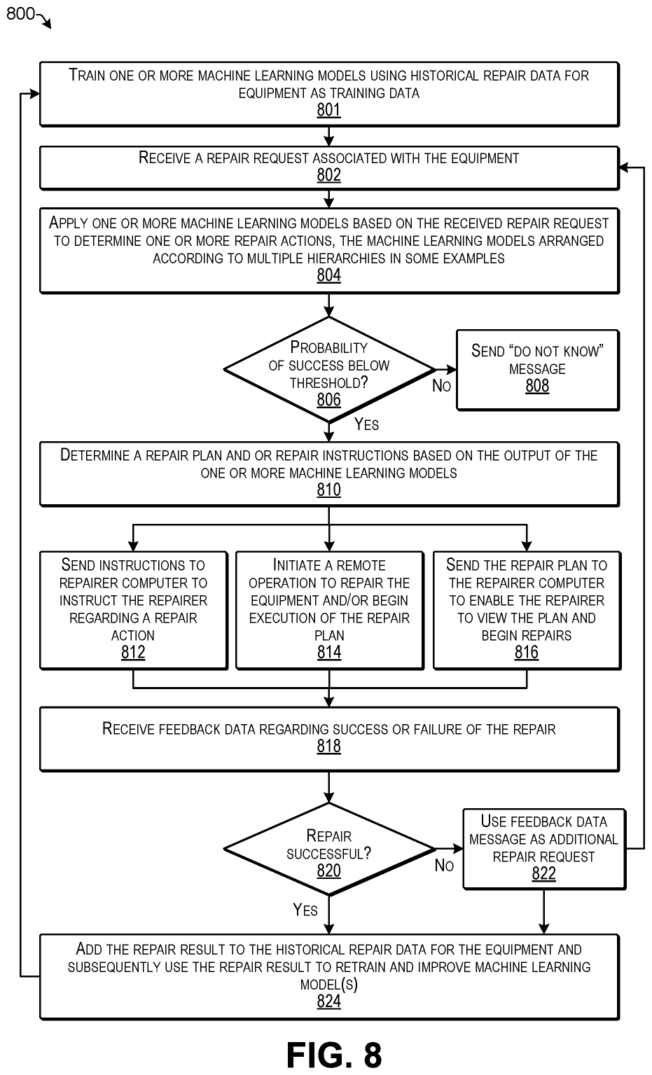

FIG. 8 is a flow diagram illustrating an example process 800 for determining a repair action according to some implementations. In some examples, the process 800 may be performed by one or more processors of the service computing device 102 by executing the repair management program 126 which may invoke one or more of the data preparation program 128, the relevant data extraction program 130, the feature extraction program 132, the model building and application program 134, and the repair plan execution program 136 for performing some of the operations described in the process 800.

At 801, the computing device may train one or more machine learning models using historical repair data for equipment as training data. Details of the training are discussed above with respect to FIGS. 2-7.

At 802, the computing device may receive a repair request associated with the equipment. For example, during the model application stage discussed above with respect to FIG. 2, the computing device may receive a repair request from one of the client computing devices discussed above with respect to FIG. 1.

At 804, the computing device may apply one or more machine learning models to determine one or more repair actions based on the received repair request. In some examples, the machine learning models may be arranged according to multiple hierarchies for equipment types and repair categories as discussed above, e.g., with respect to FIG. 5. For example, the computing device may construct a hierarchical data structure for the equipment including a first hierarchy and a second hierarchy, the first hierarchy including a plurality of equipment nodes corresponding to different equipment types, and the second hierarchy including a plurality of repair category nodes corresponding to different repair categories. The computing device may generate a plurality of machine learning models corresponding to the plurality of repair category nodes, respectively. In some cases, the data structure is a tree including a first equipment leaf node having multiple ones of the repair category nodes branching therefrom, the tree also including a second equipment leaf node. Based on determining that the number of possible repair actions for the equipment group corresponding to the second equipment leaf node is below the threshold number, the computing device may train a machine learning model for the equipment group corresponding to the second leaf node. Furthermore, in response to receiving a request for a repair, to the equipment, the computing device may determine that an equipment attribute of the equipment matches an equipment type corresponding to the first equipment leaf node, and may input data associated with the repair request to a machine learning model corresponding to a first one of the repair category nodes that branches from the first equipment leaf node. Furthermore, in some cases, based on an output of the machine learning model corresponding to the first repair category node, the computing device may input the data associated with the repair request into one or more additional machine learning models corresponding to one or more additional repair category nodes, respectively, branching from the first repair category node until a machine learning model corresponding to a repair category leaf node is invoked.

At 806, the computing device may determine whether a probability of success of the one or more repair actions is below a threshold probability. For instance, as discussed above with respect to FIG. 7, in some cases if the likelihood of success is low, a repair action may not be provided in response to the repair request. According, if the probability of success does not exceed the threshold, the process may go to block 808; alternatively, if the probability of success does exceed the threshold the process may go to block 810.

At 808, if the probability of success does not exceed the cost, the computing device may send an indication of a “do not know” message indicating that the repair request did not provide enough information for a repair action to be determined.

At 810, if the likelihood of success does exceed the cost, the computing device may determine a repair plan and or repair instructions based on the output of the one or more machine learning models.

At 812, the computing device may send an instruction to a repairer computer to instruct the repairer regarding performing a repair action to the equipment.

At 814, the computing device may the initiate a remote operation to repair the equipment and/or may begin execution of the repair plan.

At 816, the computing device may send the repair plan to the repairer computer to enable the repairer to view the plan and begin repairs.

At 818, the computing device may receive feedback data regarding success or failure of the repair. For example, the application computing devices may be configured by the repair application to provide a feedback report or the like regarding the success or failure of the repair.

At 820, the computing device may determine whether the repair was successful. If so, the process goes to block 824; if not, the process goes to block 822.

At 822, in some examples, the computing device may use the feedback data as an additional repair request, and the process may return to block 802 to perform additional processing based on the received feedback data.

At 824, the computing device may add the repair result to the historical repair data for the equipment, and subsequently use the repair result to retrain and improve the machine learning model(s).

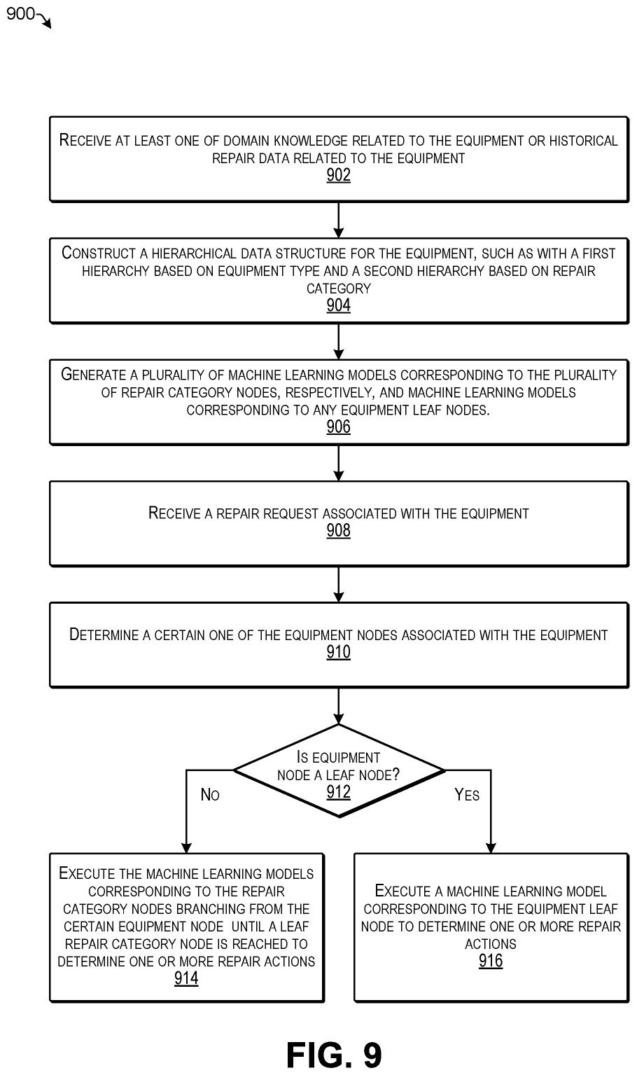

FIG. 9 is a flow diagram illustrating an example process 900 for generating and applying a hierarchy of machine learning models according to some implementations. In some examples, the process 900 may be performed by one or more processors of the service computing device 102 by executing the repair management program 126, which may invoke the model building and application program 134 for performing at least some of the operations described in the process 900.

At 902, the computing device may receive at least one of domain knowledge related to the equipment or historical repair data related to the equipment.

At 904, the computing device may construct a hierarchical data structure for the equipment including a first hierarchy and a second hierarchy. For example, the first hierarchy may include a plurality of equipment nodes corresponding to different equipment types, and the second hierarchy may include a plurality of repair category nodes corresponding to different repair categories.

At 906, the computing device may generate a plurality of machine learning models corresponding to the plurality of repair category nodes, respectively, and machine learning models corresponding to any equipment leaf nodes.

At 908, the computing device may receive a repair request associated with the equipment.

At 910, the computing device may determine a certain one of the equipment nodes associated with the equipment.

At 912, the computing device may determine whether the equipment node is a leaf node or has repair category nodes extending therefrom.

At 914, based on determining that the equipment node has repair category nodes depending therefrom, the computing device may execute the machine learning models corresponding to the repair category nodes until a leaf repair category node is reached to determine one or more repair actions based on the received repair request.

At 916, based on determining that the equipment node is an equipment leaf node with no repair category nodes extending therefrom, the computing device may execute a machine learning model corresponding to the equipment leaf node to determine one or more repair actions.

The example processes described herein are only examples of processes provided for discussion purposes. Numerous other variations will be apparent to those of skill in the art in light of the disclosure herein. Further, while the disclosure herein sets forth several examples of suitable systems, architectures and environments for executing the processes, the implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

Various instructions, processes, and techniques described herein may be considered in the general context of computer-executable instructions, such as programs stored on computer-readable media, and executed by the processor(s) herein. Generally, programs include routines, modules, objects, components, data structures, executable code, etc., for performing particular tasks or implementing particular abstract data types. These programs, and the like, may be executed as native code or may be downloaded and executed, such as in a virtual machine or other just-in-time compilation execution environment. Typically, the functionality of the programs may be combined or distributed as desired in various implementations. An implementation of these programs and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more processors; and
one or more non-transitory computer-readable media maintaining executable instructions, which, when executed by the one or more processors, configure the one or more processors to perform operations comprising:
receiving at least one of historical repair data or domain knowledge for equipment;
constructing a hierarchical data structure for the equipment including a first hierarchy and a second hierarchy, the first hierarchy including a plurality of equipment nodes corresponding to different equipment types, and the second hierarchy including a plurality of repair category nodes corresponding to different repair categories;
generating a plurality of machine learning models corresponding to the plurality of repair category nodes, respectively;
receiving a repair request associated with the equipment;
determining a first equipment leaf node corresponding to the equipment, the first equipment leaf node being one of the plurality of equipment node; and
based on determining that a first repair category node extends from the first equipment leaf node, using the machine learning model associated with the first repair category node to determine one or more repair actions based on the received repair request.

2. The system as recited in claim 1, wherein the data structure is a tree including the first equipment leaf node, the first equipment node having a plurality of the repair category nodes branching therefrom, including the first repair category node, the tree including a second equipment leaf node, the operations further comprising:
determining that a number of possible repair actions for an equipment group corresponding to the second equipment leaf node is below a threshold number; and
based on determining that the number of possible repair actions for the equipment group corresponding to the equipment leaf node is below the threshold number, training a machine learning model for the equipment group corresponding to the second equipment leaf node.

3. The system as recited in claim 2, the operations further comprising:
in response to receiving the repair request associated with the equipment, determining that an equipment attribute of the equipment matches an equipment type corresponding to the first equipment leaf node; and
inputting data associated with the repair request to a machine learning model corresponding to a second one of the repair category nodes that branches from the first equipment leaf node.

4. The system as recited in claim 3, the operations further comprising, based on an output of the machine learning model corresponding to the second repair category node, inputting the data associated with the repair request into the machine learning model associated with the first repair category node, wherein the first repair category node branches from the second repair category node and is a repair category leaf node.

5. The system as recited in claim 1, wherein an output of the machine learning model associated with the first repair category node includes the one or more repair actions and a respective probability of success associated with each repair action of the one or more repair actions.

6. The system as recited in claim 5, the operations further comprising determining a repair plan based on the one or more repair actions and the respective probability of success.

7. The system as recited in claim 6, the operations further comprising, based on the repair plan performing at least one of:
sending an order for a part for a repair;
sending a communication to assign labor to perform the repair;
sending a communication to schedule a repair time for the repair; or
remotely initiating a procedure on the equipment to effectuate, at least partially, the repair.

8. The system as recited in claim 1, the operations further comprising, based on the one or more repair actions, sending repair information to a computing device associated with the equipment in response to the repair request, wherein the repair information causes an application on the computing device to present the repair information on the computing device.

9. The system as recited in claim 8, the operations further comprising, based on the one or more repair actions, sending repair information to an equipment computing device, wherein the repair information causes the equipment computing device to initiate at least one of the repair actions on the equipment.

10. The system as recited in claim 1, the operations further comprising:
determining that a probability of success associated with the one or more repair actions is below a threshold probability; and
sending an indication to a computing device associated with the repair request that a repair is unknown.

11. The system as recited in claim 1, the operations further comprising:
determining a tradeoff between a first cost associated with providing an indication that a repair is unknown and a second cost of providing an incorrect repair instruction, and
selecting at least one of the machine learning models based on the first cost and the second cost.

12. The system as recited in claim 1, the operations further comprising:
identifying free-form text in the historical repair data, including at least one of a word, a phrase, or a topic;
determining one or more n-grams from the free-form text;
defining at least one feature for the free-form text based on assigning one or more values to the one or more n-grams;
extracting a plurality of other features from the historical repair data;
wherein generating the plurality of machine learning models includes training at least one of the machine learning models using the at least one feature and the plurality of other features.

13. The system as recited in claim 12, further comprising, for individual ones of repair incidents identified in the historical repair data, combining the one or more features from the free-form text with the plurality of other features from the historical repair data to determine respective feature vectors corresponding to the individual repair incidents.

14. A method comprising:
receiving, by one or more processors, at least one of historical repair data or domain knowledge for equipment;
constructing a hierarchical data structure for the equipment including a first hierarchy and a second hierarchy, the first hierarchy including a plurality of equipment nodes corresponding to different equipment types, and the second hierarchy including a plurality of repair category nodes corresponding to different repair categories;
generating a plurality of machine learning models corresponding to the plurality of repair category nodes, respectively;
receiving a repair request associated with the equipment;
determining a certain one of the equipment nodes associated with the equipment;
based on determining that a certain repair category node is associated with the certain equipment node using the machine learning model associated with the certain repair category node to determine one or more repair actions based on the received repair request; and
sending at least one communication to cause at least one of the repair actions to be performed.

15. One or more non-transitory computer-readable media storing instructions that, when executed by one or more processors, program the one or more processors of a system to:
receive at least one of historical repair data or domain knowledge for equipment;
construct a hierarchical data structure for the equipment including a first hierarchy and a second hierarchy, the first hierarchy including a plurality of equipment nodes corresponding to different equipment types, and the second hierarchy including a plurality of repair category nodes corresponding to different repair categories;
generate a plurality of machine learning models corresponding to the plurality of repair category nodes, respectively;
receive a repair request associated with the equipment;
determine a certain one of the equipment nodes associated with the equipment; and
based on determining that a certain repair category node is associated with the certain equipment node, use the machine learning model associated with the certain repair category node to determine one or more repair actions based on the received repair request
